(19) United States
(12) Patent Application Publication
(10) Pub. No.: US 2006/0092218 A1
(43) Pub. Date: May 4, 2006

(54) Methods and apparatus for inkjet printing

(75) Inventors: John M. White, Hayward, CA (US); Fan Cheung Sze, San Jose, CA (US); Quanyuan Shang, Saratoga, CA (US); Shinichi Kurita, San Jose, CA (US); Hongbin Ji, Santa Clara, CA (US); Janusz Jozwiak, San Ramon, CA (US); Inchen Huang, Fremont, CA (US); Emanual Beer, San Jose, CA (US)

Correspondence Address: DUGAN & DUGAN, PC, 55 SOUTH BROADWAY, TARRYTOWN, NY, 10591, US

(73) Assignee: APPLIED MATERIALS, INC.

(21) Appl. No.: 11/019,929

(22) Filed: Dec. 22, 2004

Related U.S. Application Data
(60) Provisional application No. 60/625,550, filed on Nov. 4, 2004.

(51) Int. Cl. B41J 2/15

(52) U.S. Cl. 347/40

(57) ABSTRACT

In a first aspect, a system is provided for inkjet printing. The system includes (1) at least one apparatus for inkjet printing having (a) a first inkjet print head including a first plurality of nozzles adapted to selectively dispense a first ink; (b) a second inkjet print head including a second plurality of nozzles adapted to selectively dispense a second ink; and (c) a set including the first and second print heads arranged such that the set is adapted to dispense the first and second inks into respective adjacent color wells of a display pixel on a substrate during a printing pass; and (2) a stage adapted to support the substrate and transport the substrate below the at least one apparatus for inkjet printing during the printing pass. Numerous other aspects are provided.

The present application claims priority to commonly-assigned, co-pending U.S. Provisional patent application Ser. No. 60/625,550, filed Nov. 4, 2004 and entitled “APPARATUS AND METHODS FOR FORMING COLOR FILTERS IN A FLAT PANEL DISPLAY BY USING INKJETTING” which is hereby incorporated herein by reference in its entirety for all purposes.

### CROSS REFERENCE TO RELATED APPLICATIONS

The present application is related to the following commonly-assigned, co-pending U.S. patent applications, each of which is hereby incorporated herein by reference in its entirety for all purposes:

U.S. patent application Ser. No. ______, filed Dec. 22, 2004 and titled “APPARATUS AND METHODS FOR AN INKJET HEAD SUPPORT HAVING AN INKJET HEAD CAPABLE OF INDEPENDENT LATERAL MOVEMENT” (Attorney Docket No. 9521-1); and

U.S. patent application Ser. No. ______, filed Dec. 22, 2004 and titled “METHODS AND APPARATUS FOR ALIGNING PRINT HEADS” (Attorney Docket No. 9521-3).

### FIELD OF THE INVENTION

The present invention relates generally to flat panel display manufacturing, and more particularly to methods and apparatus for inkjet printing.

### BACKGROUND

The flat panel display industry has been attempting to employ inkjet printing to manufacture display devices, in particular, color filters. One problem with effective employment of inkjet printing is that it is difficult to inkjet ink or other material accurately and precisely on a substrate while having high throughput. Accordingly, there is a need for improved methods and apparatus for efficiently positioning inkjet heads above drop locations on a substrate (e.g., so as to reduce the number of printing passes required for depositing ink on the substrate).

### SUMMARY OF THE INVENTION

In a first aspect of the invention, a system is provided for inkjet printing. The system includes (1) at least one apparatus for inkjet printing having (a) a first inkjet print head including a first plurality of nozzles adapted to selectively dispense a first ink; (b) a second inkjet print head including a second plurality of nozzles adapted to selectively dispense a second ink; and (c) a set including the first and second print heads arranged such that the set is adapted to dispense the first and second inks into respective adjacent color wells of a display pixel on a substrate during a printing pass; and (2) a stage adapted to support the substrate and transport the substrate below the at least one apparatus for inkjet printing during the printing pass. In some embodiments, multiple sets of inkjet print head may be used simultaneously.

In a second aspect of the invention, an apparatus is provided for inkjet printing. The apparatus includes (1) a first inkjet print head including a first plurality of nozzles adapted to selectively dispense a first ink; (2) a second inkjet print head including a second plurality of nozzles adapted to selectively dispense a second ink; and (3) a set including the first and second print heads arranged such that the set is adapted to dispense the first and second inks into respective adjacent color wells of a display pixel on a substrate during a printing pass.

In a third aspect of the invention, a first method is provided for inkjet printing. The first method includes the steps of (1) grouping a plurality of inkjet print heads into a set; (2) arranging the plurality of print heads in the set such that the set is operable to dispense different inks into respective adjacent color wells of a display pixel on a substrate during a printing pass; and (3) employing the set to dispense the different inks into respective adjacent color wells of the display pixel on the substrate during the printing pass.

In a fourth aspect of the invention, a second method is provided for inkjet printing. The second method includes the steps of (1) at least one of (a) offsetting a first inkjet print head within a set including first and second inkjet print heads relative to the second print head in a direction perpendicular to a print direction by an offset amount; and (b) rotating the set about a central axis; (2) positioning the set to a home position; and (3) starting inkjet printing using the set such that inks from the first and second print heads are dispensed into respective adjacent color wells of a display pixel during an inkjet printing pass. Numerous other aspects are provided in accordance with these and other aspects of the invention.

Other features and aspects of the present invention will become more fully apparent from the following detailed description, the appended claims and the accompanying drawings.

### BRIEF DESCRIPTION OF THE DRAWINGS

FIG. 1 is a schematic diagram of a system for inkjet printing in accordance with an embodiment of the present invention.

FIG. 2A is a schematic diagram of a top view of a portion of an apparatus for inkjet printing in accordance with an embodiment of the present invention.

FIG. 2B is a schematic diagram of an enlarged top view of a portion of the apparatus for inkjet printing shown in FIG. 2A in accordance with an embodiment of the present invention.

FIG. 3 illustrates a method of inkjet printing in accordance with an embodiment of the present invention.

### DETAILED DESCRIPTION

The present invention provides methods and apparatus for improving printing efficiency by reducing the number of times a substrate is required to pass under an inkjet printer head. According to the present invention, multiple sets of print heads may be arranged to dispense ink onto a substrate as the substrate is transported below the sets. Each set may include more than one print head disposed such that the set is operable to dispense a different ink into adjacent color wells of display pixels on the substrate. This may be achieved by using a different print head for each color ink and offsetting the print heads within a set relative to each other in a direction perpendicular to the print direction by an offset amount (e.g., an offset distance). Additionally or alternatively, the above functionality may be achieved by rotating the sets of print heads about a central axis such that a center-to-center distance in a direction perpendicular to the print direction between corresponding nozzles of adjacent print heads is approximately equal to a center-to-center distance of adjacent color wells of the display pixels. For example, and as described further below, using three sets of print heads, each set including three print heads (e.g., nine print heads in total), three different inks may be deposited into each display pixel of a display object in one third the number of printing passes required by conventional systems. In some embodiments, each set may be used to print a different display object (or column of display objects).

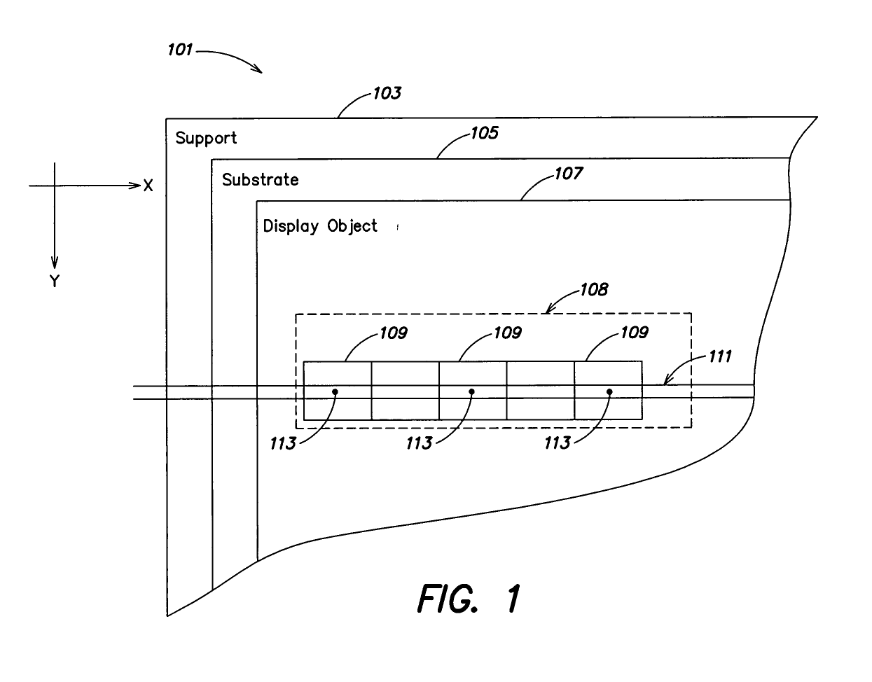

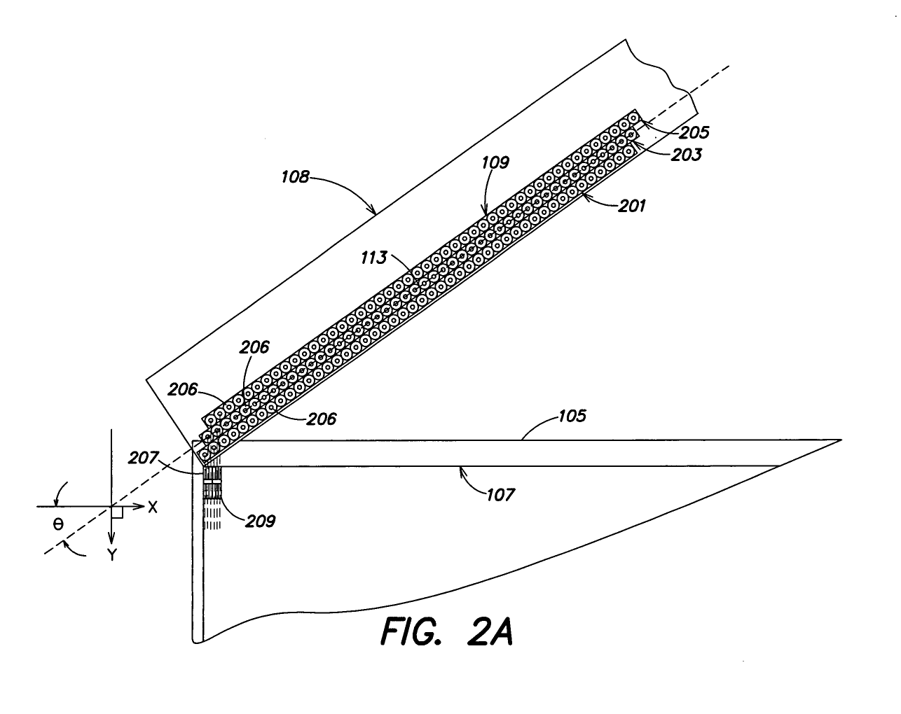

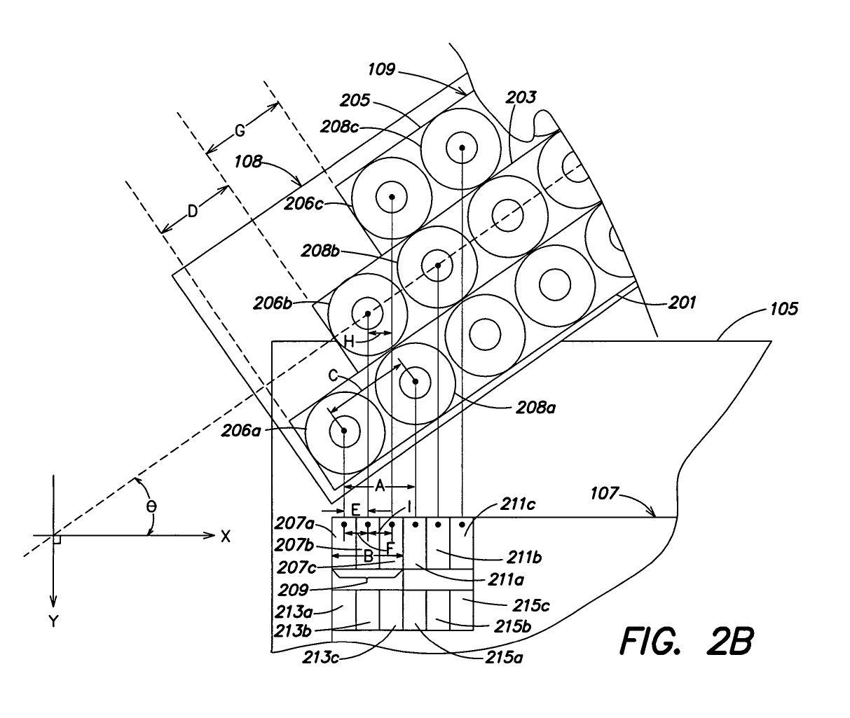

FIG. 1 is a schematic diagram of a system for inkjet printing in accordance with an embodiment of the present invention. With reference to FIG. 1, the system 101 may include a support 103 adapted to support and transport a substrate 105 during flat panel display manufacturing or the like, and more specifically, during inkjet printing. The substrate 105 may include one or more display objects 107 into which ink may be dispensed during inkjet printing. Details of the one or more display objects 107 of the substrate 105 are described below with reference to FIGS. 2A and 2B. While only one display object is shown in FIG. 1, it will be understood that the substrate 105 include more than one display object. Note that a substrate 105 may be comprised of glass, polymers, and/or any other suitable material.

The system 101 may include one or more apparatus 108 for inkjet printing in accordance with an embodiment of the present invention. Each of the one or more apparatus 108 may include one or more sets 109 of inkjet print heads (not separately shown) adapted to dispense ink into the display objects 107 of the substrate 105. Although the example apparatus 108 includes three sets 109 of inkjet print heads, in some embodiments, the apparatus 108 may include a larger or smaller number of sets 109.

The one or more sets 109 of print heads may be coupled above the substrate support 103. More specifically, the system 101 for inkjet printing may include a rail 111, which extends above the support 103, to which the one or more sets 109 of print heads are coupled. As will be described below, each set 109 may be coupled to the rail 111 such that the set 109 may independently rotate (e.g., about a central axis 113) above the support 103. In addition, each set 109 may be independently moveable laterally (e.g., along an axis) above the support 103. Further, within each set 109, individual print heads may be moveable relative to each other, both along a longitudinal axis of the print heads and along an axis that is perpendicular to the longitudinal axis of the print heads.

During inkjet printing, the support 103 may transport the substrate 105 below the one or more sets 109 of inkjet print heads and such sets 109 of inkjet print heads may dispense one or more inks onto one or more display objects 107 included in the substrate 105. In some embodiments, the support 103 transports the substrate 105 along the y-axis, thereby defining a print direction. However, in other embodiments, the support 103 may transport the substrate 105 in a different direction. Each time the support 103 transports the substrate 105 below the one or more sets 109 may be referred to as a printing pass.

FIG. 2A is a schematic diagram of a top view of a portion of the apparatus 108 of FIG. 1. With reference to FIG. 2A, as stated, the apparatus 108 for inkjet printing may include one or more sets 109 of inkjet print heads (only one of which is shown in FIG. 2A). Each of the one or more sets 109 may include a plurality of inkjet print heads 201-205 adapted to dispense respective inks. More specifically, each print head 201-205 may include a plurality of nozzles 206 adapted to selectively dispense ink (e.g., red, green, blue and/or another color). In some embodiments, a set 109 may include three inkjet print heads 201-205 (although a larger or smaller number of inkjet print heads 201-205 may be employed). Further, in some embodiments, each of the inkjet print heads 201-205 may dispense different inks (e.g., inks of different colors) and/or other fluids or materials. However, in some embodiments, two or more of the print heads 201-205 may dispense the same ink (e.g., ink of the same color) and/or other fluids or materials.

The display object 107 may include a plurality of display pixels 209 each of which may include a plurality of color wells 207 into which ink may be dispensed. The plurality of inkjet print heads 201-205 in the set 109 may be arranged such that the set 109 is adapted to dispense a first ink from a first print head 201, a second ink from a second print head 203, and so on (e.g., a third ink from a third print head 205), into respective adjacent color wells 207 of a display pixel 209 on a substrate 105 during a printing pass. More specifically, to achieve the above result, the set 109 may be rotated (e.g., by an angle θ relative to an x-axis) about a central axis 113 (FIG. 1). Additionally or alternatively, one or more of the plurality of print heads 201-205 (e.g., the first 201 and third print heads 205) may be offset (e.g., along a longitudinal axis of such print heads 201, 205) from remaining print heads (e.g., the second print head 203) in the set 109. The rotating and/or offsetting of the print heads may be effected by independently operable drive motors (or other drivers) for each print head. Details of such rotating and/or offsetting are described below with reference to FIG. 2B.

Although rotating and/or offsetting are described below, it should be understood that any method may be employed to arrange the plurality of print heads 201-205 within each set 109 such that the set 109 is adapted to dispense a first ink from a first print head 201 and a second ink from a second print head 203 into respective adjacent color wells 207 of a display pixel 209. In other words, the rotating may be performed on individual print heads or on an entire set of print heads. Likewise, the offsetting may be performed on individual print heads or on an entire set of print heads. In this manner, a number of printing passes required to dispense the inks from the plurality of inkjet print heads 201-205 into respective adjacent color wells 207 of display pixels 209 on the substrate 105 during inkjet printing may be reduced. Likewise, although the examples described herein consider a set with three print heads and offsets based upon a center print head, any number of print heads may be employed and the center of the set may shift as differently sized sets with different numbers of print heads are employed. Also, although only one set 109 of the apparatus 108 for inkjet printing is illustrated in FIG. 2A, it should be understood that remaining sets 109 in the apparatus 108 are adapted to dispense ink in a similar manner into display pixels 209 traveling under such sets 109 during a printing pass.

FIG. 2B is a schematic diagram of an enlarged top view of a portion of the apparatus for inkjet printing shown in FIG. 2A in accordance with an embodiment of the present invention. With reference to FIG. 2B, the plurality of print heads 201-205 are arranged within the set 109 such that the set 109 may dispense a first ink from a first nozzle 206a of the first print head 201 into a first color well 207a, a second ink from a first nozzle 206b of the second print head 203 into a second color well 207b that is adjacent the first color well 207a, and so on (e.g., the set may be adapted to dispense a third ink from a first nozzle 206c of the third print head 205 into a third color well 207c that is adjacent the second color well 207b), as the support 103 transports the substrate 105 in the printing direction (e.g., along the y-axis) below the apparatus 108 (e.g., during a printing pass). Similarly, the set 109 may dispense ink into color wells of other display pixels 209. For example, the set 109 may dispense the first ink from a second nozzle 208a of the first print head 201 into a fourth color well 211a included in another display pixel, the second ink from a second nozzle 208b of the second print head 203 into a fifth color well 211b that is adjacent the fourth color well 211a, and so on (e.g., the set may be adapted to dispense the third ink from a second nozzle 208c of the third print head 205 into a sixth color well 211c that is adjacent the fifth color well 211b), during the printing pass. Further, the set 109 may dispense ink into color wells 213a-c, 215a-c as the support 103 transports such color wells below the set 109. In this manner, the set 109 may dispense ink into color wells 207a-c, 211a-c, 213a-c, 215a-c of display pixels 209 during the printing pass. Further, although FIG. 2B illustrates ink dispensed from two nozzles 206, 208 of each of the first through third print heads 201-205, it should be understood that the set 109 may be adapted to dispense ink from remaining nozzles of the plurality of print heads 201-205 in a manner similar to that described above such that ink may be deposited into one or more additional display pixels 209 (not shown) included in the display object 107 during the printing pass.

To achieve the above-described arrangement of the plurality of print heads 201-205 within the set 109, the set 109 may be rotated (e.g., by an angle θ relative to the x-axis) about a central axis (not shown in FIG. 2B; 113 in FIG. 2A) such that a center-to-center distance A along an axis (e.g., x-axis) perpendicular to the printing direction (e.g., y-axis) of adjacent nozzles in a print head 201-205 is substantially equal to the display pixel width B. In one embodiment, the display pixel width is 120 microns (although a larger or smaller width may be employed. In some embodiments, the angle of rotation θ may be cos⁻¹ (A/C), where C is the center-to-center distance between adjacent nozzles of a print head along a longitudinal axis of the print head as shown in FIG. 2B. However, the angle of rotation θ may be based on a different relationship.

Additionally or alternatively, the first print head 201 may be offset in a first direction (e.g., along a longitudinal axis of such print head 201) by an amount D from the second print head 203 such that a center-to-center distance E in a direction (e.g., along the x-axis) perpendicular to the print direction (e.g., along the y-axis) between corresponding nozzles (e.g., 206a and 206b) of such print heads 201-203 is approximately equal to a center-to-center distance F of adjacent color wells (e.g., 207a and 207b) of the display pixel 209.

Similarly, the third print head 205 may be offset in a second direction (e.g., along a longitudinal axis of such print head 201) by an amount G from the second print head 203 such that a center-to-center distance H in a direction (e.g., along the x-axis) perpendicular to the print direction (e.g., along the y-axis) between corresponding nozzles (e.g., 206c and 206b) of such print heads 203,205 is approximately equal to a center-to-center distance I of adjacent color wells (e.g., 207b and 207c) of the display pixel 209. In some embodiments, dimensions D, E and F may match dimensions G, H and I, respectively (although dimensions D, E and F may differ from dimensions G, H and I, respectively). Further, in some embodiments, the center-to-center distance F, I of adjacent color wells in a display pixel 209 may be about 360 microns (although a larger or smaller distance may be employed). Although only the arrangement of print heads 201-205 in one set 109 of the apparatus 108 for inkjet printing is illustrated in FIG. 2B, it should be understood that print heads in remaining sets 109 of the apparatus 108 may be arranged in a similar manner.

The offsetting may occur at the time the set 109 is calibrated and configured to print onto a particular display pixel layout of a display object. Alternatively, the offsetting may be performed during printing to accommodate different display objects or other requirements. The set 109 may include and/or be coupled to a driver to independently move the print heads to create the offset.

In some embodiments, multiple sets 109 of print heads may be employed simultaneously in a single print pass. For example, in a system for inkjet printing 101 according to the present invention, three sets 109 of print heads, each including three print heads (for a total of nine prints heads) may be arranged side by side and independently adjustable in a lateral direction. Thus, in operation, the simultaneous use of nine print heads according to the present invention may result in as few as one third the number of print passes being required to complete printing of a series of display objects 107 as compared to conventional systems. In some embodiments, multiple sets 109 may be employed to print on different display objects 107 simultaneously. For example, when printing on a substrate 105 that has a display object layout of three display objects 107 (e.g., three columns) by four display objects 107 (e.g., four rows), one set 109 per column of display objects 107 may be used to concurrently print each of the display objects 107 in a column. Thus, each set 109 of print heads may print a different column of display objects 107. Note that when printing on a substrate 105 that has a display object layout of, for example, five display objects 107 (e.g., five columns) by six display objects 107 (e.g., six rows), five sets 109 may be used concurrently to print the color filters in the most optimal manner. In all cases, the sets 109 may be independently adjustable in a lateral direction (e.g., along the x-axis, perpendicular to the print direction) to allow each set to be aligned with a different display object 107 and/or column of display objects 107. In some embodiments, all or a subset of all the sets 109 may concurrently print a single display object 107, for example, when a display object 107 is particularly large. Also note that the sets 109 may include a number of print heads that corresponds with the number of different color inks that may be used. In other words, if a display object 107 includes four colors, the sets 109 may include four print heads, one print head for each of the four colors.

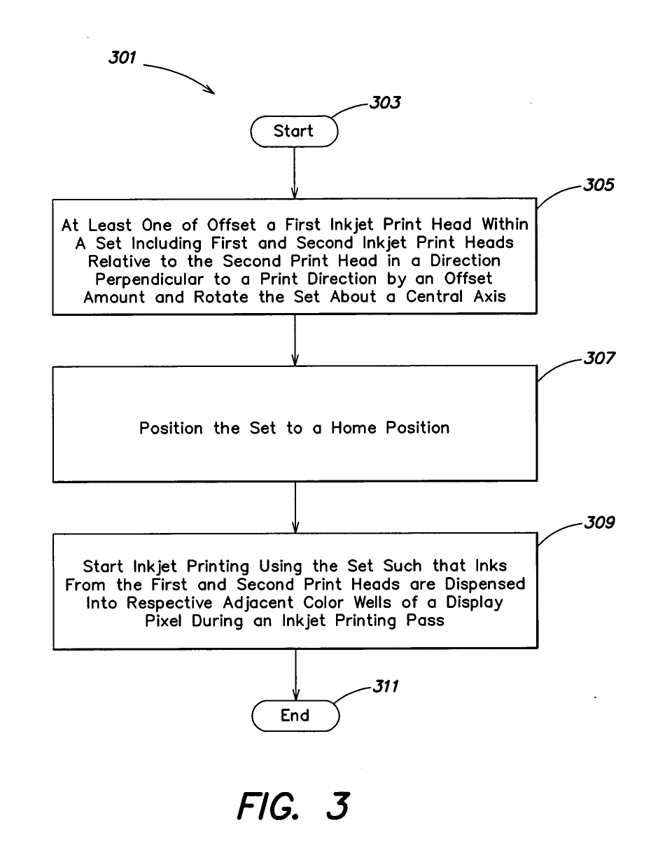

The operation of the system for inkjet printing is now described with reference to FIGS. 1-2B and with reference to FIG. 3, which illustrates a method 301 of inkjet printing in accordance with an embodiment of the present invention. With reference to FIG. 3, in step 303 the method 301 begins. In step 305, at least one of a first inkjet print head within a set including first and second inkjet print heads is offset relative to the second print head in a direction perpendicular to a print direction by an offset amount. The set 109 is then rotated about a central axis. More specifically, the first inkjet print head 201 may be offset (e.g., via hardware or software) relative to the second print head 203 by an offset amount (e.g., a distance) D along a longitudinal axis of the print head 203. In this manner, the first print head 201 is offset from the second print head 203 in a direction (e.g., along the x-axis) perpendicular to the print direction (e.g., along the y-axis) so that a center-to-center distance E in the direction perpendicular to the printing direction between corresponding nozzles 206a, 206b of the first and second print heads 201-203 is approximately equal to a center-to-center distance F of adjacent color wells 207a, 207b of the display pixel 209 into which ink will be dispensed. Another print head (e.g., a third print head 205) may be offset from the second print head 203 in a similar manner.

The set 109 also may be rotated about the central axis (e.g., by an angle θ) such that a center-to-center distance A between adjacent nozzles (e.g., 206a, 208a) of a print head (e.g., 201) within the set 109 in a direction (e.g., along the x-axis) perpendicular to a print direction (e.g., along the y-axis) is substantially equal to the display pixel width B (FIG. 2B). By rotating the set 109 about a central axis 113 (e.g., by an angle θ), all print heads 201-205 included in the set 109 are rotated by the angle θ. Alternatively, in some embodiments, one or more of the print heads 201-205 may be rotated by the angle θ about respective central axes of such print heads 201-205 to achieve the above result.

In this manner, the print heads 201-205 in the set 109 are arranged for inkjet printing in accordance with an embodiment of the present invention. Thereafter, step 307 is performed.

In step 307, the set is positioned to a home position. For example, the substrate support 103 may be employed to move the substrate 105 to a position from which the apparatus 108 including the set 109 may start inkjet printing (e.g., the home position). The home position may be selected such that the apparatus 108 does not omit display pixels 209 on the display object 107 and may dispense ink to display pixels 209 on the display object 107 in an orderly fashion during inkjet printing using one or more printing passes. In some embodiments, this step 307 may be repeated for each of N sets 109 of print heads for each of N display objects 107 (or N columns of display objects 107) on the substrate 105. In some embodiments, each set 109 may be adjusted both laterally (e.g., along the x-axis) and along the print direction (e.g., along the y-axis) so as to position the different sets 109 so that they may print without a gap between the sets 109.

In step 309, inkjet printing using the set 109 is started such that inks from the first and second print heads are dispensed into respective adjacent color wells of a display pixel during an inkjet printing pass. For example, different inks (e.g., inks of different colors) may be dispensed from the first and second print heads 201-203, respectively, into adjacent color wells (e.g., 207a, 207b) during the printing pass. Although only one set is shown in FIGS. 2A-2B, it should be understood that a plurality of sets 109 may be employed to dispense ink into display pixels 209 of display objects 107 during inkjet printing. One or more printing passes may be employed to dispense ink into the display pixels 209 included in the display objects 107 of the substrate 105. Because inks from different print heads 201-205 (e.g., different inks) may be dispensed into adjacent color wells (e.g., 207a, 207b) of display pixels 209 in a display object 107 during a single printing pass using the present methods and apparatus, a total number of printing passes required to dispense ink into display pixels 209 on the substrate 105 may be reduced compared to conventional inkjet printing systems.

Thereafter, step 311 may be performed. In step 311, the method 301 ends.

Through use of the method 301 inkjet printing may be improved by reducing a total number of printing passed required to dispense inks into display pixels 209 of display objects 107 included in a substrate 105. Compared to conventional systems, the present method improves inkjet printing efficiency and may reduce required maintenance.

The foregoing description discloses only exemplary embodiments of the invention. Modifications of the above disclosed apparatus and methods which fall within the scope of the invention will be readily apparent to those of ordinary skill in the art. For instance, in one or more embodiments, the inkjet heads 201-205 may move during printing while the substrate 105 remains stationary. In some embodiments, the apparatus and methods of the present invention may be applied to semiconductor processing and/or electronic device manufacturing. For example, resist patterns may be inkjetted onto substrates which may include glass, polymers, semiconductors, and/or any other suitable materials that are practicable. Thus, the jetted material may include ink, polymers, or any other suitable material that is practicable.

Accordingly, while the present invention has been disclosed in connection with exemplary embodiments thereof, it should be understood that other embodiments may fall within the spirit and scope of the invention, as defined by the following claims.

The invention claimed is:

1. A system for inkjet printing, comprising:
at least one apparatus for inkjet printing having:
a first inkjet print head including a first plurality of nozzles adapted to selectively dispense a first ink;
a second inkjet print head including a second plurality of nozzles adapted to selectively dispense a second ink; and
a set including the first and second print heads arranged such that the set is adapted to dispense the first and second inks into respective adjacent color wells of a display pixel on a substrate during a printing pass; and
a stage adapted to support the substrate and transport the substrate below the at least one apparatus for inkjet printing during the printing pass.

2. The system of claim 1 wherein the set is further adapted to rotate about a central axis such that a center-to-center distance between adjacent nozzles of the first print head within the set in a direction perpendicular to a print direction is substantially equal to a width of the display pixel.

3. The system of claim 1 wherein the set is further adapted to offset the first print head relative to the second print head in a direction perpendicular to a print direction by an amount such that a center-to-center distance in the direction perpendicular to the print direction between corresponding nozzles of the first and second print heads is approximately equal to a center-to-center distance of adjacent color wells of the display pixel in a display object on the substrate into which ink will be dispensed.

4. The system of claim 1 wherein the first print head is adapted to rotate about a central axis such that a center-to-center distance between adjacent nozzles of the first print head in a direction perpendicular to a print direction is substantially equal to a width of the display pixel.

5. The system of claim 1 wherein the set is further adapted to reduce a number of printing passes required to dispense the first and second inks into respective adjacent color wells of display pixels on the substrate during inkjet printing.

6. The system of claim 1 wherein the first and second inks are different colored inks.

7. An apparatus for inkjet printing, comprising:
a first inkjet print head including a first plurality of nozzles adapted to selectively dispense a first ink;
a second inkjet print head including a second plurality of nozzles adapted to selectively dispense a second ink; and
a set including the first and second print heads arranged such that the set is adapted to dispense the first and second inks into respective adjacent color wells of a display pixel on a substrate during a printing pass.

8. The apparatus of claim 7 wherein the set is further adapted to rotate about a central axis such that a center-to-center distance between adjacent nozzles of the first print head within the set in a direction perpendicular to a print direction is substantially equal to a width of the display pixel.

9. The apparatus of claim 7 wherein the set is further adapted to offset the first print head relative to the second print head in a direction perpendicular to a print direction by an amount such that a center-to-center distance in the direction perpendicular to the print direction between corresponding nozzles of the first and second print heads is approximately equal to a center-to-center distance of adjacent color wells of the display pixel in a display object on the substrate into which ink will be dispensed.

10. The apparatus of claim 7 wherein the first print head is adapted to rotate about a central axis such that a center-to-center distance between adjacent nozzles of the first print head in a direction perpendicular to a print direction is substantially equal to a width of the display pixel.

11. The apparatus of claim 7 wherein the set is adapted to reduce a number of printing passes required to dispense the first and second inks into respective adjacent color wells of display pixels on the substrate during inkjet printing.

12. The apparatus of claim 7 wherein the first and second inks are different colored inks.

13. A method of inkjet printing, comprising:
grouping a plurality of inkjet print heads into a set;
arranging the plurality of inkjet print heads in the set such that the set is operable to dispense different inks into respective adjacent color wells of a display pixel on a substrate during a printing pass; and
employing the set to dispense the different inks into respective adjacent color wells of the display pixel on the substrate during the printing pass.

14. The method of claim 13 wherein arranging the plurality of print heads in the set such that the set is operable to dispense different inks into respective adjacent color wells of the display pixel on the substrate during the printing pass includes rotating the set about a central axis such that a center-to-center distance between adjacent nozzles of a print head within the set in a direction perpendicular to a print direction is substantially equal to a width of the display pixel.

15. The method of claim 13 wherein arranging the plurality of print heads in the set such that the set is operable to dispense different inks into respective adjacent color wells of the display pixel on the substrate during the printing pass includes offsetting a first print head relative to a second print head in a direction perpendicular to a print direction by an amount such that a center-to-center distance in the direction perpendicular to the print direction between corresponding nozzles of the first and second print heads is approximately equal to a center-to-center distance of adjacent color wells of a display pixel in a display object into which ink will be dispensed.

16. The method of claim 13 wherein arranging the plurality of print heads in the set such that the set is operable to dispense different inks into respective adjacent color wells of the display pixel on the substrate during the printing pass includes rotating a print head about a central axis such that a center-to-center distance between adjacent nozzles of the print head in a direction perpendicular to a print direction is substantially equal to a width of the display pixel.

17. The method of claim 13 further comprising reducing a number of printing passes required to dispense the different inks into respective adjacent color wells of display pixels on the substrate during inkjet printing.

18. The method of claim 13 wherein the different inks include different colored inks.

19. A method of inkjet printing, comprising:
at least one of:
offsetting a first inkjet print head within a set including first and second inkjet print heads relative to the second print head in a direction perpendicular to a print direction by an offset amount; and
rotating the set about a central axis;
positioning the set to a home position; and
starting inkjet printing using the set such that inks from the first and second print heads are dispensed into respective adjacent color wells of a display pixel during an inkjet printing pass.

20. The method of claim 19 wherein:
offsetting the first inkjet print head within the set relative to the second print head in a direction perpendicular to the print direction by an offset amount includes offsetting the first inkjet print head relative to the second print head in the direction perpendicular to the print direction by an amount such that a center-to-center distance in the direction perpendicular to the print direction between corresponding nozzles of the first and second print heads is approximately equal to a center-to-center distance of adjacent color wells of the display pixel; and
rotating the set about a central axis includes rotating the set such that a center-to-center distance between adjacent nozzles of the first print head within the set in the direction perpendicular to the print direction is substantially equal to a width of the display pixel.

21. A method of inkjet printing, comprising:
grouping a plurality of inkjet print heads into a set; and
arranging the plurality of inkjet print heads in the set such that the set is operable to dispense different inks into respective adjacent color wells of a display pixel on a substrate during a printing pass.

22. The method of claim 21 further comprising grouping a plurality of sets of inkjet print heads into an inkjet printing system.

23. The system of claim 1 further comprising at least a second set of inkjet print heads adapted to dispense the first and second inks into respective adjacent color wells of an adjacent display pixel on the substrate during a printing pass.

24. The system of claim 7 further comprising at least a second set of inkjet print heads adapted to dispense the first and second inks into respective adjacent color wells of an adjacent display pixel on the substrate during a printing pass.
